(19) United States
(12) Patent Application Publication
(10) Pub. No.: US 2006/0256139 A1
(43) Pub. Date: Nov. 16, 2006

(54) PREDICTIVE TEXT COMPUTER SIMPLIFIED KEYBOARD WITH WORD AND PHRASE AUTO-COMPLETION (PLUS TEXT-TO-SPEECH AND A FOREIGN LANGUAGE TRANSLATION OPTION)

(76) Inventor: David Cameron Gikandi, Broadbeach (AU)

Correspondence Address: DAVID CAMERON GIKANDI, 15 ALBERT AVENUE, SUITE 292, BROADBEACH, 4218, AU

(21) Appl. No.: 11/308,013

(22) Filed: Mar. 3, 2006

Related U.S. Application Data
(60) Provisional application No. 60/679,765, filed on May 11, 2005.

(51) Int. Cl. G09G 5/00

(52) U.S. Cl. 345/689

(57) ABSTRACT

A predictive text personal computer simplified keyboard with word and phrase auto-completion. It has a smaller keypad with each key representing several letters/characters so that only 9 keys are required to represent the entire alphabet of 26 characters. It also has screens and selection buttons which, when combined with predictive text input software such as the T9 dictionary from Tegic Communications, Inc. (www.t9.com), enables the user to type just a few keys to have entire words or phrases automatically typed into their document, thus saving typing time and avoiding the frustration of hunting for characters across a keyboard. It also offers language translation and speech capabilities, both enhanced by predictive text auto-completion.

### RELATED APPLICATIONS

The present application is a continuation-in-part application of U.S. provisional patent application Ser. No. 60/679,765, filed May 11, 2005, for WHOLE HAND COMPUTER MOUSE WITH A BUTTON FOR EACH FINGER, by David Cameron Gikandi, included by reference herein and for which benefit of the priority date is hereby claimed.

### FIELD OF THE INVENTION

The present invention relates to computer keyboards (text input devices) and more particularly pertains to a new keyboard with predictive text features that offer auto-completion of words and phrases, with additional translation and text-to-speech capabilities.

### BACKGROUND OF THE INVENTION

Ever since people started typing, they have looked for ways to speed this up. Learning how to type is time-consuming and not many people end up learning how to touch-type. Many people still hunt-and-peck around a keyboard, taking a long time to type even the shortest pieces of text. Typing is frustrating for many people, and the fact that keyboards have at least 26 keys to cover the alphabet means that someone has to hunt for one out of 26 keys each time they wish to input just one character. It would be far simpler to rely on, for example, only 9 keys to represent the entire alphabet intelligently and effectively.

Even if a person knows how to type fast, they still have to type in every single character that they wish to use. Wouldn't it be great to have a computer keyboard that allows the user to save on the amount of typing they need to do in order to say what they wish to say? For example, what if a person could type in just three characters and for that they end up with a complete and correct phrase written for them?

Another problem that people today face in a multi-lingual world is that of communicating with people who speak a different language. This is so whether they are communicating by e-mail or type, or whether they wish to communicate when they are traveling in person to distant lands. Wouldn't it be nice if a person could type in just a few characters and have a device quickly complete their sentence in their native language and then translate it into the foreign language and speak it out so that the foreign person can hear it? In this way, the device would be speaking in the foreign language on behalf of the user.

The same goes for people with speech impediments. These people have always looked for a way to quickly and vocally communicate with people. Wouldn't it be nice to have a device that allows such a person to quickly type in what they wish to say in as few keystrokes as possible, and then have the device speak it out?

All previous keyboard inventions have required the user to type an entire word by typing each letter in the word. This new invention enables the user to type in only the first few letters of a word or phrase (or an acronym of it) and automatically have that word or phrase completed by the keyboard. Previous keyboards also have way too many keys, making it difficult to find just the one you need to use. The entire English alphabet can be represented by just about 9 keys, reducing on the need to search across many keys to find the character you are looking for.

The biggest disadvantage of previous computer keyboard inventions is that they require every letter in a word or phrase to be typed. This obviously takes longer than if only the first few letters of a word or phrase (or an acronym of it) were all that were required.

Also, the previous keyboards need to have a key for each letter and number. This makes them much bigger than this new invention, and this requires the user to hunt around the keyboard for the letter they need to type in next. This new invention has far fewer keys (only 9 keys are required for the whole alphabet instead of 26) and in sequential order, meaning that the user can locate key they want easier and faster.

Because of the above-mentioned disadvantages, it takes a lot of time to type in text, especially for users who do not have speed typing training.

It is therefore an object of the invention to improve efficiency, productivity and performance on Windows and other operating systems and programs by simplifying and speeding typing (text input) by offering predictive text and auto-completion of words and phrases, which reduces the number of letters that need to be typed in to have a word or phrase entered into a document. The keyboard, through the T9 dictionary or similar, is pre-loaded with thousands of words, emoticons, and punctuation. It predicts what the user wants to say as they type. If the user types in a word that T9 does not recognize, it will learn it and recognize it the next time they enter the word.

It is another object of the invention to speed up computer use by reducing the number of keys representing the alphabet from 26 keys to 9 keys, and making them sequential (as opposed to the random QWERTY keyboards arrangement) thereby reducing the need to hunt all over the keyboard for the letter a user needs to type in.

It is another object of the invention to offer a keyboard that is smaller than other keyboards, hence more convenient to pack, ship and use.

It is another object of the invention to allow various functions to be programmed into the buttons on the keyboard to allow users of a wide variety of software programs to customize the keyboard's functionality to suit their particular needs.

It is another object of the invention to enable users to change the keyboard's housing/casing using artistically designed, third-party snap-on covers.

It is another object of the invention to have the keyboard as a battery operated, stand alone unit with an additional speaker and text-to-speech software installed on it. This unit can be carried around by people with speech impediments (such as the mute or people with autism) to help them communicate with other people. They can type in what they wish to say very quickly using the predictive text features and it then uses the text-to-speech software to say out aloud whatever they typed in.

It is another object of the invention to have it carry language translation software and a text-to-speech engine. It can then be used by travelers in foreign countries to help them communicate in another language. They would type in what they wish to say in their native language quickly using the predictive text features and the portable keyboard would then translate that into the foreign language and the text-to-speech engine would then speak it out aloud.

Still further objects and advantages will become apparent from a consideration of the ensuing descriptions and drawings.

Insofar as I am aware, no computer keyboard formerly developed provides predictive text and auto-completion. Mobile phones do employ predictive text and auto-completion. These mobile phones primarily use the T9 text-input software from Tegic Communications to achieve this. This new keyboard invention will also rely on the T9 software (or similar) to achieve this. This keyboard invention is designed to make predictive text and auto-completion convenient and easy for personal computers.

### SUMMARY OF THE INVENTION

In accordance with the present invention, there is provided a predictive text personal computer simplified keyboard with word and phrase auto-completion. It has a smaller keypad with each key representing several letters/characters so that only 9 keys are required to represent the entire alphabet of 26 characters. It also has screens and selection buttons which, when combined with predictive text input software such as the T9 dictionary from Tegic Communications, Inc. (www.t9.com), enables the user to type just a few keys to have entire words or phrases automatically typed into their document, thus saving typing time and avoiding the frustration of hunting for characters across a keyboard. It also offers language translation and speech capabilities, both enhanced by predictive text auto-completion.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top view of a keyboard constructed in accordance with the invention;

FIG. 2 is a rear perspective view of a keyboard in FIG. 1, showing the keyboard and its base. It is opened up to face the user at an incline;

FIG. 3 is a right perspective view of a keyboard in FIG. 1. It is resting flat on its base; and

FIG. 4 is a left perspective view of a keyboard in an alternative embodiment whereby the base is of a different construction that employs a telescopically adjustable swivel neck base.

For purposes of clarity and brevity, like elements and components will bear the same designations and numbering throughout the Figures.

### DESCRIPTION OF THE PREFERRED EMBODIMENT

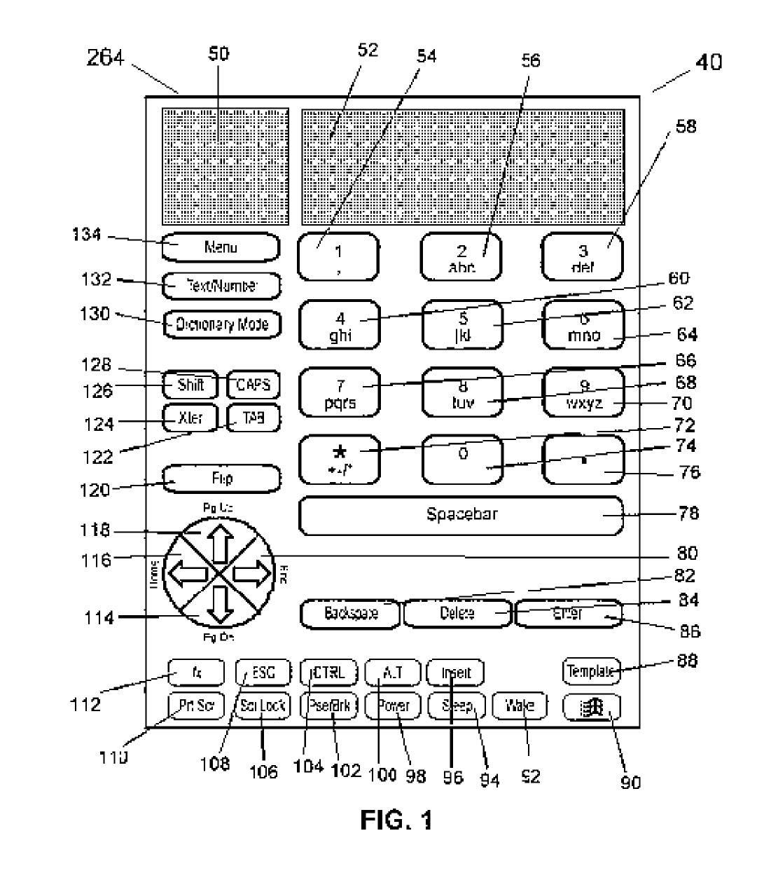

FIG. 1 is a top view of a Simplified Keyboard 40 constructed in accordance with the invention. This illustrates the concept discussed in this invention. The Simplified Keyboard 40 has a Small Screen 50 that lists the words and phrases that the keyboard's predictive text engine suggests to the user so that the user may select from that list the word or phrase they wish to use. It also has an optional Big Screen 52 that holds the text typed in so far so that the user does not have to keep looking up onto the computer monitor screen to see what they have typed in so far. This Big Screen 52 also displays at the top the various modes that the user is in and other information as required.

The Simplified Keyboard 40 also has the following buttons:
1, Button 54. This button is used to input the numeral ‘1’ and the coma (,).
2abc Button 56. This button is used to input the numeral ‘2’ and the letters a, b, and c.
3def Button 58. This button is used to input the numeral ‘3’ and the letters d, e, and f.
4ghi Button 60. This button is used to input the numeral ‘4’ and the letters g, h, and i.
5jkl Button 62. This button is used to input the numeral ‘5’ and the letters j, k, and l.
6nmo Button 64. This button is used to input the numeral ‘6’ and the letters m, n, and o.
7pqrs Button 66. This button is used to input the numeral ‘7’ and the letters p, q, r, and s.
8tuv Button 68. This button is used to input the numeral ‘8’ and the letters t, u, and v.
9wxyz Button 70. This button is used to input the numeral ‘9’ and the letters w, x, y, and z.
*+−/ Button 72. This button is used to input the characters *+− and /.
0 Button 74. This button is used to input the numeral ‘0’.
. (Period) Button 76. This button is used to input the period (.) character.
Spacebar Button 78. This button is used to enter a space character. It is also used to automatically select the highlighted word or phrase in the Small Screen 50. By default, the first word or phrase in the Small Screen 50 is the highlighted one unless the user scrolls to another one.
Enter Button 86. This button is used as the regular enter key common in all keyboards. It is also used to accept the highlighted word or phrase in the Small Screen 50.
Template Button 88. This button is used to bring up a list of template frequently used phrases into the Small Screen 50 for quick entry to reduce the need for typing them out again.
Function Button 112. This button is used in combination with the other numeral buttons. For example, holding down on the function button 112 and keying in the 1, button 54 and releasing the function button 112 is equivalent to pressing on the F1 key on a regular keyboard. This button can also be programmed to achieve other ends in combination with other keys.
Flip/Select Button 120. This button is used to select the next suggested word or phrase on the Small Screen 50. It can also be used in combination with the up and down arrow keys to achieve the same.
Character Button 124. This brings up a list of characters not found on the Simplified Keyboard 40. The user can then use the cursor keys to select the one they wish to enter into their text.
Dictionary Mode Button 130. This button activates and deactivates the T9 (or other) predictive text-input software dictionary.
Text/Number Button 132. This flips the Simplified Keyboard 40 between text and number entry modes.
Menu Button 134. This button brings up a menu with various settings and options.

The following buttons work as they normally do in all other keyboards:

Right Cursor Button 80, Backspace Button 82, Delete Button 84, Windows Button 90, Wake Button 92, Sleep Button 94, Insert Button 96, Power Button 98, ALT Button 100, Pause/Break Button 102, CTRL Button 104, Scroll Lock Button 106, Escape Button 108, Print Screen Button 110, Down Cursor Button 114, Left Cursor Button 116, Up Cursor Button 118, TAB Button 122, Shift Button 126, CAPS Lock Button 128.

The Speaker 264 is used to read out the text that is displayed on the Big Screen 52 when the invention is being used to assist a speech-impaired person to communicate with others, or when it is being used as a language translation device.

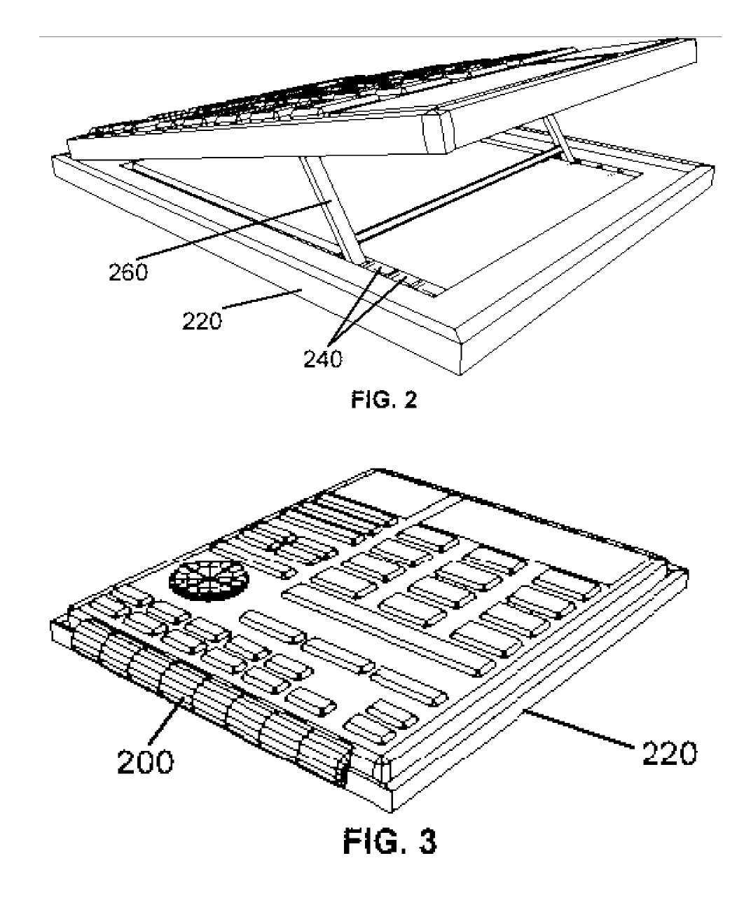

FIG. 2 is a rear perspective view of a Simplified Keyboard 40 in FIG. 1, showing the Simplified Keyboard 40 and its base. It is opened up to face the user at an incline. The flat base 220 has Notches 240 on it. The Simplified Keyboard 40 has a frame 260 under it. The user can adjust the incline of the Simplified Keyboard 40 by setting the frame 260 on any one of the many Notches 240 on the flat base 220.

FIG. 3 is a right perspective view of a Simplified Keyboard 40 in FIG. 1. it is resting flat on its base. It shows the hinge 200 that attaches the Simplified Keyboard 40 to its flat base 220.

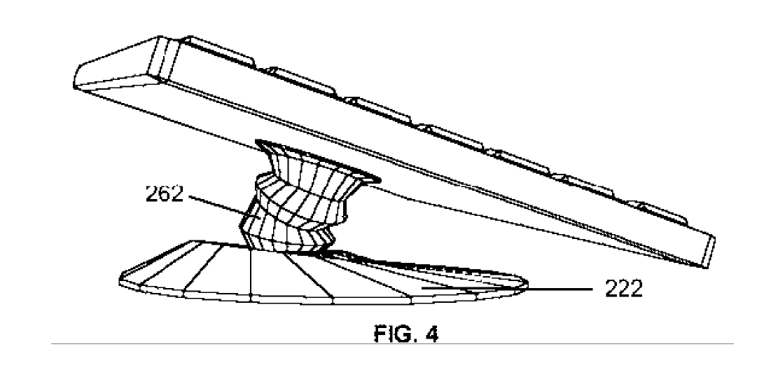

FIG. 4 is a left perspective view of a Simplified Keyboard 40 in an alternative embodiment whereby the base is of a different construction that employs a telescopically adjustable swivel neck 262 and a round base 222. This simply shows one of the many alternative ways the Simplified Keyboard 40 can be made to incline (if needed).

In Operation:

The keyboard's main feature is the predictive text input and auto-completion. As the user types in each subsequent number or letter, the predictive text dictionary automatically attempts to auto-complete the word or phrase or suggest words or phrases that it thinks the user may be intending to use, thus saving the user several keystrokes. The T9 predictive text dictionary can be licensed from the Tegic Communications company (www.t9.com). This invention can also use any other suitable predictive text dictionary. The Simplified Keyboard 40, through the T9 dictionary or similar, is pre-loaded with thousands of words, emoticons, and punctuation. It predicts what the user wants to say as they type. If the user types in a word that T9 does not recognize, it will learn it and recognize it the next time they enter the word.

Here is an example of how this Simplified Keyboard 40 works:

(1) The user presses the 2abc button 56 followed by the 3def Button 58 and the 4ghi button 60. This in English (the Simplified Keyboard 40 can be used for any language and modified to do so if necessary) will show a list of three-letter words in the Small Screen 50 that are composed of the letters in these three keys, plus any phrases that are programmed to appear when those three buttons are keyed in that order. The word “beg” will be selected by default (according to the current implementation of the T9 predictive text dictionary). To use this word, the user simply presses the Spacebar button 78 or the Enter Button 86 and it will be added to the text already typed in and visible in the Big Screen 52 and the computer monitor.

(2) If the user does not wish to use the default first-selected word, pressing the Flip/Select Button 120 will move the selection down the list of words in the Small Screen 50 to select alternative words or phrases. Alternatively, they can hold down the Flip/Select Button 120 and press a number key corresponding to the word they wish to use. For example, if they wish to use the fourth word on the list, they would press and hold down on the Flip/Select Button 120, press on the 4ghi button 60, and release the Flip/Select Button 120.

Here are some other examples of buttons pressed and the corresponding words that come up on the Small Screen 50:
When a user presses the numeric keys 2-2-7-3, the T9 predictive text dictionary would cause the following words would show on the Small Screen 50: case, care, base, card, bare, cape.
When a user presses the numeric keys 2-6-9, the following words would show on the Small Screen 50: any, boy, box, cow, box.
When a user presses the numeric keys 7-2-4-3, the following words would show on the Small Screen 50: said, page, paid, raid, rage.
When a user presses the numeric keys 7-2-6, the following words would show on the Small Screen 50: ran, Sam, san, pan, ram.
When a user presses the numeric keys 7-2-9, the following words would show on the Small Screen 50: say, saw, pay, raw, ray.

Here are some other examples showing how a user can type in entire phrases using this invention:
Pressing the 1 numeric key gives the following word/phrase options: One; Won; Want; @; The
Pressing the 2,3,2,4,5 numeric key sequence (letters A,F,A,I,K) gives the following word/phrase options: As Far As I Know
Pressing the 2,8 numeric key sequence (letters C,U) gives the following word/phrase options: See You
Pressing the 4,2,6,3 numeric key sequence (letters H,A,N,D) gives the following word/phrase options: Hand; Have A Nice Day; Game

Here are other functions and operations:
Template Button 88. This button is used to bring up a list of template frequently used phrases into the Small Screen 50 for quick entry to reduce the need for typing them out again.
Function Button 112. This button is used in combination with the other numeral buttons. For example, holding down on the function button 112 and keying in the 1, button 54 and releasing the function button 112 is equivalent to pressing on the F1 key on a regular keyboard. This button can also be programmed to achieve other ends in combination with other keys.
Character Button 124. This brings up a list of characters not found on the Simplified Keyboard 40. The user can then use the cursor keys to select the one they wish to enter into their text.
Dictionary Mode Button 130. This button activates and deactivates the T9 (or other) predictive text-input software dictionary.
Text/Number Button 132. This flips the Simplified Keyboard 40 between text and number entry modes.
Menu Button 134. This button brings up a menu with various settings and options.

This Simplified Keyboard 40 is portable, can run on batteries, and can be used for language translation or to assist speech-impaired people to communicate with others. For language translation, the user would type in a sentence in their native language (assisted by the predictive text engine so as to save time and typing), select the language they wish that sentence to be translated into, and the Simplified Keyboard 40 would then go ahead and translate that sentence, displaying it onscreen and optionally speaking it out on the Speaker 264. For assisting the speech impaired, the speech impaired user would type in a sentence (assisted by the predictive text engine to save time and typing) and the Simplified Keyboard 40 would then go ahead and speak it out on the Speaker 264. In both the language translation mode and speech impaired assistance mode, the predictive text dictionary would be in operation so that the user accomplishes their tasks rapidly.

Although the description above contains many specifics, these should not be construed as limiting the scope of this invention but as merely providing illustrations of some of the preferred embodiments of this invention. For example:
The Simplified Keyboard 40 can have other shapes such as circular, oval, triangular, etc.
The Simplified Keyboard 40 detailed here is for desktop computers (or external laptop mouse use), but design modifications can be made to make the mouse fit into a laptop or handheld computer either as part of the main housing of these devices or as an external device.
The Simplified Keyboard 40 can be designed for left- or right-handed users.
A scroll wheel can be added to the Simplified Keyboard 40.
The Simplified Keyboard 40 can use any of various technologies to connect to the computer (such as wireless, cable, or Bluetooth).
The Simplified Keyboard 40 is also intended to come with optional decorative snap-on covers (like mobile phones do) allowing the user to change the top and/or bottom covers of the Simplified Keyboard 40 to a design of their liking.
The Simplified Keyboard 40 can be made with plastic or with any other suitable materials and constructions.
The base can be constructed in a variety of ways to achieve the inclining.
The Simplified Keyboard 40 can be built with less or more than these buttons.
The Simplified Keyboard 40 can employ any suitable technologies to accomplish said objectives and functionality.
The Simplified Keyboard 40 can also be ergonomically designed to achieve various health and comfort ends.
Speech recognition can be added to the Simplified Keyboard 40 to achieve various ends such as allowing a user to input using voice.
It can also be built to be adjustable for various hand sizes.
It is also meant to be built for various languages whereby the keys are re-mapped for different languages and language-specific predictive text dictionaries (software) loaded. The T9 text-input software from Tegic Communications, for example, currently comes in over 40 languages.
The buttons can be replaced with a touch-screen so that instead of having physical buttons to press, the Simplified Keyboard 40 features a touch-screen surface.
The buttons can be arranged and grouped differently to achieve various ends, such as reducing the number of buttons or making it easier to use for certain user groups such as engineers, designers, the physically challenged and so on.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A predictive text computer simplified keyboard with word and phrase auto-completion (plus text-to-speech and a foreign language translation option) for speeding up typing/text input and providing text-to-speech and language translation capabilities, comprising:
means for inputting text;
means for displaying a list of words and phrases generated by the predictive text engine;
means for selecting a word or phrase from the list of words and phrases proposed by the predictive text engine;
means for accepting the selected word or phrase in the list of suggested words and phrases from the predictive text engine; and
means for speaking the text out aloud.
